(19) United States
(12) Patent Application Publication
(10) Pub. No.: US 2004/0187475 A1
(43) Pub. Date: Sep. 30, 2004

(54) Apparatus and method for reducing radiated sound produced by a rotating impeller

(76) Inventors: William J. Usab JR., West Windsor, NJ (US); Alan J. Bilanin, Princeton, NJ (US)

Correspondence Address: DAVID M QUINLAN, PC, 32 NASSAU STREET, SUITE 300, PRINCTON, NJ, 08542, US

(21) Appl. No.: 10/702,272

(22) Filed: Nov. 6, 2003

Related U.S. Application Data
(63) Continuation-in-part of application No. 10/627,851, filed on Jul. 25, 2003.
(60) Provisional application No. 60/425,282, filed on Nov. 12, 2002.
(60) Provisional application No. 60/429,351, filed on Nov. 27, 2002.
(60) Provisional application No. 60/425,303, filed on Nov. 12, 2002.

(51) Int. Cl. F02K 3/02

(52) U.S. Cl. 60/204; 60/226.1

(57) ABSTRACT

A propulsor that provides thrust by increasing the velocity of a fluid working medium comprises a rotatable impeller including a plurality of impeller blades spaced from each other, each blade having an airfoil cross-section that provides lift as the fluid working medium travels over it. A stator with plural stator blades directs the fluid working medium into the impeller. The stator blades are arranged to vary a parameter of the flow, such as the flow angle relative to each impeller blade, in repeating cycles in a manner that causes the propulsor to generate a predetermined acoustic signature characterized by predetermined acoustic energy levels in the fluid at given locations spaced from the propulsor. In a preferred form of the propulsor, the flow angle is varied so as to cause the flow relative to each impeller blade to begin to separate and then reattach during each cycle. This provides delayed stall lift enhancement that enables the impeller to generate a predetermined thrust at a reduced impeller angular velocity, thus reducing the overall acoustic energy produced by the propulsor.

### CROSS-REFERENCE TO RELATED APPLICATIONS

This application is a continuation-in-part of application Ser. No. 10/627,851, filed Jul. 25, 2003, which claims the benefit of U.S. provisional application No. 60/425,282, filed Nov. 12, 2002, and U.S. provisional application No. 60/429,351, filed Nov. 27, 2002. This application claims the benefit of U.S. provisional application No. 60/425,303, filed Nov. 12, 2002. All four of these related applications are incorporated herein by reference.

### STATEMENT REGARDING GOVERNMENT RIGHTS

This invention was made with Government support under contract number N00014-02-M-0210 awarded by the U.S. Navy. The Government has certain rights in the invention.

### BACKGROUND OF THE INVENTION

1. Field of the Invention

The present invention relates to an apparatus and method to reduce sound produced by rotating machinery, and more particularly, to an apparatus and method of reducing acoustic energy radiating from a rotating impeller by introducing specific non-uniformities into the flow entering the impeller.

2. Description of Related Art

There have been many attempts at reducing the sound radiated by rotating machinery such as turbomachinery and marine propulsors with one or more pairs of rotating and stationary blade rows. The great majority of these attempts have involved trying to make the flow through the device as uniform as possible, while using different prime number blade counts in adjacent blade rows to reduce the frequency of the acoustic energy produced by the device. Known configurations also incorporate uneven spacing of stator blades to try to further reduce radiated acoustic sound levels, as in U.S. Pat. No. 4,253,800 to Segawa et al., No. 4,474,534 to Thode, and Nos. 5,588,618 and 5,634,611 to Marze et al.

As those skilled in the art know, propulsion devices (for example, airplane propellers and marine propulsors), turbomachinery (for example, axial and centrifugal flow compressors), pumps, turbines (axial and centrifugal configurations), and the like, all involve the transfer of energy between a rotating impeller and a working medium fluid. The tools for designing such apparatus have become very sophisticated, using advanced mathematical techniques incorporating complex algorithms requiring the computing capacity of powerful modern computers. But even the most advanced design tools still generally assume steady-state flow conditions. That is, current fluid dynamics design approaches assume that the flow parameters at a given point are constant for any particular set of operating conditions, meaning that at any given location on, say, the blade of a marine propeller operating under a particular set of conditions, the flow parameters do not change over time.

One commentator has put it like this: “In the decades since 1934, engineers and mathematicians have amassed a body of aerodynamic theory sufficient to design Boeing 747s and stealth fighters. As sophisticated as these aircraft may be, their design and function are based on steady-state principles: the flow of air around the wings and the resulting forces generated by that flow are constant over time.” Dickinson, “Solving the Mystery of Insect Flight,” Scientific American, June 2001, pp. 49-57. The same steady-state assumptions are used to design complex propulsion systems such as jet engines. Yet a steady-state fluid dynamics analysis suggests that the seemingly simple way insects propel themselves is actually impossible.

Science has recently come to understand that insect flight in fact involves significant variations over time of the flow field around the insects' wings, caused by complex flapping/rotational wing motion. In other words, understanding insect flight requires non-steady-state analysis. As it turns out, one phenomenon insects take advantage of was observed many years ago. Francis et al., “The Flow Near a Wing Which Starts Suddenly from Rest and then Stalls,” Rep. Memo Aeronautical Research Comm., Aeronautics Laboratory, University of Cambridge, England, Rept. No. 1561, Aug. 8, 1933, shows that a wing that starts at an angle of attack in excess of that associated with steady-state stall travels several chord lengths before experiencing flow separation and loss of lift. An insect uses the delayed stall associated with translational wing motion (in addition to taking advantage of lift and wake capture associated with rotational wing motion) in order to fly. Dickinson et al., “Wing Rotation and the Aerodynamic Basis of Flight,” Science, Vol. 284, Jun. 18, 1999, pp. 1954-60.

The flow over a wing W at the onset of aerodynamic stall is illustrated schematically in FIG. 1. The wing W has a conventional airfoil cross-section, and in normal, level flight the flow stays attached to the top and the bottom of the airfoil. As those skilled in the art understand, when the flow stays attached to the upper and lower airfoil surfaces, the wing generates a lift force L. It is also well known that the magnitude of the lift L is proportional to the airfoil's angle of attack α. This is the angle between the vector representing the airfoil's velocity U_{∞} through the air and the airfoil chord (a line connecting the leading and trailing edges of the airfoil cross-section). If the angle of attack α increases beyond a critical value, the flow separates from the top surface of the wing W and the lift decreases to a much lower steady stalled value. This is called “stall,” and under normal circumstances it is avoided at all costs.

FIG. 1 illustrates notionally the flow phenomena that occur when an airfoil first enters the flow regime associated with steady-state stall. FIG. 1 shows a wing W traveling from right to left at a high angle of attack αFIG. 1A shows the wing at time t, just as the wing encounters flow conditions that will lead to steady-state stall. Each of FIGS. 1B to 1E shows the wing position at a very short incremental time τ after the previous figure. As illustrated in FIG. 1, steady-state stall is a process that actually takes a finite time to develop into flow separation from the wing surface. FIG. 1A illustrates that the process of aerodynamic stall begins with a staring vortex C that is generated in the wake of the wing and a vortex CA at the leading edge of the wing W. This vortical flow continues to develop and become more complex as time passes, but as the flow is just beginning to separate from the top surface of the wing, the leading edge vortex CA causes the wing to generate lift as if the flow were still attached to its top surface. In fact, the leading edge vortex CA actually increases the local velocity over the wing, which increases the lift L as illustrated in FIG. 1B. As the wing W continues to travel at an angle of attack α greater than the stall limit, this vortical flow continues to increase in complexity, and the flow eventually does separate from the top surface of the wing, as represented in FIGS. 1D and 1E. It has been suggested that insects can take advantage of this momentary increased lift associated with the beginning of flow separation because they flap their wings and reverse wing direction, causing the flow to reattach before stall actually sets in fully. Dickinson, “Solving the Mystery of Insect Flight” (see above).

Of course, an insect is able to move its wings relative to the air using a complex, periodic flapping and pitching motion that changes the wings' orientation and prevents them from fully stalling. The difficulty in taking the same advantage of this delayed stall mechanism in a manmade device lies in finding a practicable way of introducing the cyclical flow variations necessary repeatedly to approach stall and then permit the working medium flow to reattach as in normal airfoil operation.

Turbomachinery, such as compressors and fans, use rotating blades with an airfoil cross-section to increase the pressure of the working medium. Marine propulsors, such as ships' propellers, torpedo propulsors, and water jets, also use rotating blades with airfoil cross-sections. The amount of energy transferred between any such device and its working medium is a direct result of the amount of lift generated by the blades. Accordingly, any manner of increasing such lift will improve the performance of these devices. However, there is no known mechanism by which such rotating machinery can take advantage of the significant transient lift increases achievable by operating in a delayed stall regime.

Non-steady-state flow leading to delayed stall has been studied. The rotating blades of a helicopter in forward flight experience cyclical variations in angle of attack that can lead to operation in the delayed stall regime for some of the blade travel. For that reason, The Boeing Company, in the course of its helicopter design efforts, has developed and published algorithms for analyzing delayed stall (usually called “dynamic stall” when referring to helicopter rotor blades). Harris et al., “Rotor High Speed Performance, Theory vs. Test,” J. of Amer. Helicopter Soc., Vol. 15, No. 3, April 1970, pp. 35-44; Tarzanin, “Prediction of Control Loads Due to Blade Stall,” J. of Amer. Helicopter Soc., Vol. 17, No. 2, April 1972, pp. 33-46. In particular, a formulation of the Boeing dynamic stall model by Wayne Johnson has proven especially useful for that purpose. Johnson, “Rotorcraft Aerodynamics Models for a Comprehensive Analysis,” Proc. Amer. Helicopter Soc. 54^{th} Annual Forum, Washington, D.C., May 20-22, 9998, pp. 71-94; Nguyen and Johnson, “Evaluation of Dynamic Stall Models with UH-60A Airloads Flight Test Data,” Proc. Amer. Helicopter Soc. 54^{th} Annual Forum, Washington, D.C., May 20-22, 1998, pp. 576-88.

More recently, unsteady flow lift enhancement principles, initially identified and studied in relation to the hydrodynamics of fish, have been explored as concepts that might be incorporated into the control surfaces of small underwater vehicles for the generation of very high maneuvering forces. Preliminary studies have shown that actively controlled flapping control surfaces can generate much higher maneuvering forces than what is possible using steady-state hydrodynamic forces. Bandyopadhyay, “Maneuvering Hydrodynamics of Fish and Small Underwater Vehicles,” Integrative and Comparative Biology, Volume 42, No. 1, February 2002, pp. 102-117.

Further, it has been observed in a modeling study done at the NAVSEA Naval Underwater Weapons Center Division that a reduction in the rotational speed of a marine propulsor can lead to a reduction of radiated noise attributable to various mechanisms, such as blade tonal noise due to wake deficit, trailing edge singing, and ingested turbulence. These noise sources have been shown to be a function of rotational rate to the power of 4, 5, and 6, respectively. Based on a scaling analysis, it was shown that a reduction of 5% in a propulsor's revolutions per minute can reduce noise by 3-5 dB. Bandyopadhyay, et al., “A Biomimetic Propulsor for Active Noise Control: Experiments”, NUWC-NPT Tech. Rept. 11,351, NAVSEA Naval Undersea Warfare Center (NUWC) Division, Newport, R.I., March 2002, pp. 1-15. Accordingly, if it were possible to increase the thrust generated by a particular propulsor, it would be likewise be possible to reduce its rotational speed and thus the noise it generates.

However, even though many approaches have been proposed for reducing the noise radiated by rotating impellers, there has been little work directed toward tailoring the acoustic signature of such devices to meet particular goals by introducing non-uniformities into the entry flow thereof. And in spite of prior art studies and work with algorithms involved in analyzing delayed stall lift enhancement, the fact remains that it has not been utilized in turbomachinery, propulsion devices, and other applications discussed herein to reduce the noise radiated by such devices or tailor their acoustic signatures.

### SUMMARY OF THE INVENTION

It is an object of the present invention to provide an apparatus and method that utilize periodic, cyclical flow variations to tailor the acoustic signature of an impeller.

In accordance with one aspect of the invention, an apparatus for providing propulsive force by increasing the velocity of a fluid working medium comprises a rotatable impeller including a plurality of lifting elements spaced from each other, wherein each lifting element has an airfoil cross-section that provides lift as the fluid working medium travels relative thereto, and a device for directing the fluid working medium into an inlet of said impeller, wherein the device varies a parameter of the flow relative to each lifting element in repeating cycles to cause said apparatus to generate a predetermined acoustic signature characterized by predetermined acoustic energy levels in the fluid at given locations relative to said apparatus.

In accordance with another aspect of the invention, such the apparatus further comprises an axial flow device, wherein the lifting elements are arranged in a first cascade around a hub capable of rotating on an axis, the device includes a second plurality of lifting elements having an airfoil cross-section arranged in a second cascade around the hub, and the airfoils in the second cascade have at least one predetermined geometric property for controlling the parameter by varying circumferentially or radially or both from element to element, the property including at least one of lifting element pitch, cross-sectional thickness, camber distribution, chord length, and element-to-element spacing.

In one preferred form, the first cascade includes an axial flow impeller, the second cascade includes at least one of (i) a stator with a plurality of stationary blades and (ii) a second axial flow impeller having a plurality of impeller blades mounted for rotation on the axis in a direction opposite the direction of rotation of the first impeller, and the parameter is a flow angle at which the flow is directed to said first-mentioned impeller, each said blade of said second cascade being oriented at a predetermined exit angle for circumferentially varying said flow angle to cause the flow relative to each lifting element to begin to separate from the lifting element and then reattach thereto during each cycle.

Yet another aspect of the invention relates to a method of optimizing the acoustic energy signature generated by a propulsor that increases the velocity of a fluid working medium to provide a predetermined propulsive force by rotating an impeller having a plurality of lifting elements spaced from each other, comprising the steps of varying a parameter of the flow relative to each said lifting element in repeating cycles to cause the propulsor to generate a predetermined acoustic signature characterized by predetermined acoustic energy levels in the fluid at given locations spaced from the propulsor, and choosing values of the parameter that cause the flow relative to each lifting element to begin to separate from the lifting element and then reattach thereto during each cycle to increase the propulsive force generated by the impeller at a given rotational speed, thereby permitting generation of the predetermined thrust at a reduced rotational speed.

In an advantageous application of the method, the parameter is at least one of the magnitude of the velocity of the flow entering said inlet of said cascade, the direction of the velocity of the flow entering said inlet of said cascade, and the swirl in the flow entering said inlet of said cascade.

### BRIEF DESCRIPTION OF THE DRAWINGS

The objects of the invention will be better understood from the detailed description of its preferred embodiments which follows below, when taken in conjunction with the accompanying drawings, in which like numerals refer to like features throughout. The following is a brief identification of the drawing figures used in the accompanying detailed description.

FIG. 1, comprising FIGS. 1A to 1E, schematically illustrates the flow over a wing at the onset of aerodynamic stall.

FIG. 2 is a side view, partially in section, of a fan for a turbofan jet engine in which delayed stall lift enhancement may be advantageously incorporated.

FIG. 3 is a cascade view of the stator and rotor stages of the fan shown in FIG. 2.

FIG. 4 illustrates how the flow varies over time for a single rotor blade in the cascade shown in FIG. 3.

FIG. 5 is a plot that illustrates the lifting force on the blade shown in FIG. 4, depicting the increase in average lift achieved with delayed stall lift enhancement as compared to the potential maximum steady-state lift.

FIG. 6 is a schematic depiction of a test rig used to demonstrate the increased pressure rise achieved using a stator/rotor configuration incorporating delayed stall lift enhancement.

FIG. 7 plots data generated using the test rig shown in FIG. 6 to compare various rotor/stator configurations incorporating delayed stall lift enhancement and a baseline configuration representing the prior art.

FIG. 8 depicts an alternate embodiment of delayed stall lift enhancement incorporated in a centrifugal compressor.

FIG. 9 illustrates how thrust and moment variations can be theoretically eliminated in a propulsion system with delayed stall lift enhancement.

FIG. 10 is a depiction of a mathematic model for analyzing flow over a marine propeller.

FIG. 11 is a flow chart representing an algorithm used to maximize the thrust generated by the marine propeller shown in FIG. 10.

FIG. 12 is a graph that illustrates the results of maximizing the thrust generated by the propeller shown in FIG. 10 using the algorithm of FIG. 11.

FIG. 13 is a graph that plots the estimated sound power reduction of a stator/rotor system as a function of the reduction in rotor rotational velocity possible by using the present invention to generate the same thrust as a system without the invention.

### DETAILED DESCRIPTION OF THE PREFERRED EMBODIMENTS

Delayed Stall Lift Enhancement

As noted above, the present invention can provide rotating machinery, such as a propulsor, with an acoustic signature tailored to a particular application, including a signature that reduces the total acoustic energy produced at a given thrust level. However, delayed stall lift enhancement will be discussed first, because of its close relation to the noise-reduction aspects of the invention.

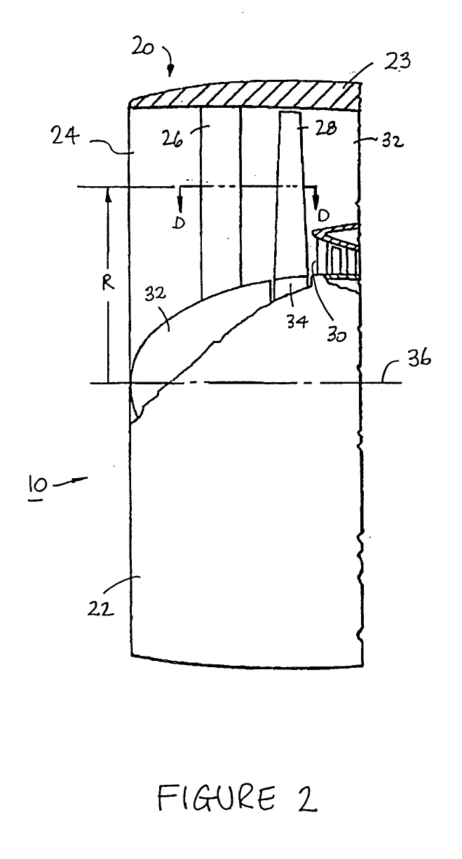

FIG. 2 is a schematic depiction of a turbofan jet engine 10 with a fan stage 20, shown partially in section, that incorporates delayed stall lift enhancement. As in conventional engines, the fan stage 20 includes a duct 22 with an annular duct wall 23 forming an inlet 24 that introduces air into the engine. The duct wall 23 encloses ga row of stationary inlet guide vanes comprising a plurality of stator blades 26 and a rotating fan comprising a plurality of rotor blades 28. After passing through the fan stage, an inner annular portion of the air enters a core engine inlet 30 to be compressed and burned in the conventional fashion, while the rest of the air bypasses the core engine, also in conventional fashion. A hub 32 supports the inner portion, or root, of the stator blades 26, which are typically attached at their outer tips to the duct wall 23. The rotor blades 28 are attached to a disk 34 that is driven about an axis 36 by a turbine (not shown) of the jet engine.

As this description proceeds, it will become apparent that delayed stall lift enhancement has application to technologies other than conventional turbomachinery such as that depicted in FIG. 2. However, it is described first in this context, which permits a clear exposition of its basic underlying principles. Other specific and general applications will be mentioned after the basic principles have been explained.

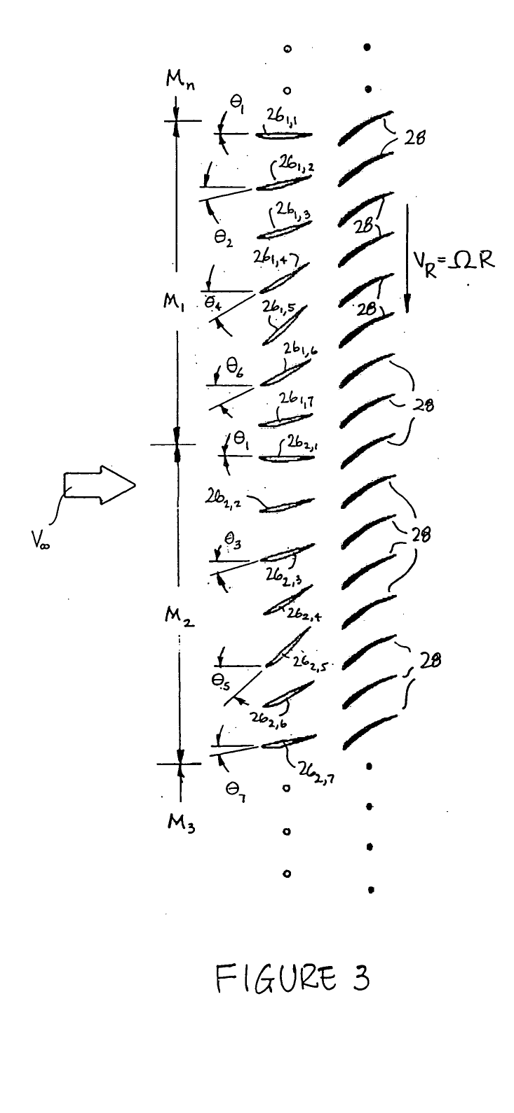

FIG. 3 represents the fan stage 20 looking radially inwardly at a given radius R (FIG. 2), showing a cascade of stator blades 26 and a cascade of rotor blades 28. This view shows a section taken along line D-D in FIG. 2, “unrolled” to enable depiction in two dimensions of the blades' relative positions. As the disk 34 rotates, the motion of the rotor blades 28 as seen in FIG. 3 is in a straight line shown by the velocity vector V_{R}. The velocity of the rotor blades is R times the rotational velocity of the disk; that is, V_{R}=ΩR.

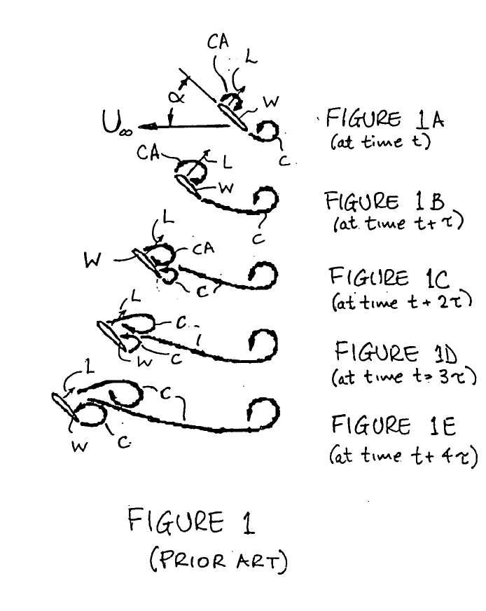

As is conventional, each rotor blade 28 has an airfoil cross-section so that it comprises a lifting element that generates a lift force as the working medium fluid (which is air in a jet engine) travels over the rotor blade. This lift is the ultimate source of the pressure rise across the fan stage. As with the airfoil discussed above in connection with FIG. 1, the lift generated by each rotor blade is determined by the velocity of the working medium fluid relative to the blade and the angle of attack between the velocity vector and the blade's camber line. As in a conventional fan, the orientation of the rotor blades 28 is constant around the circumference of the fan stage. That is, they have a fixed alignment relative to the axis 36 of the fan. The orientation of each blade relative to the fan axis may twist along the radial extent of the blade, as is also conventional, but a cross-section of each rotor blade 28 at a given radius R will be identical in shape and orientation to the other rotor blades, as in FIG. 3.

To incorporate delayed stall lift enhancement, the stator blades 26 are arranged to orient the working medium relative to the rotor blades in a fashion that takes advantage of the increased lift associated with delayed stall. To that end, the working medium approaches the stator blades axially to the engine as represented by the velocity vector V_{∞}. The stator blades direct the working medium flow toward the inlet plane of the cascade of rotor blades 28 at angles that vary cyclically around the stator circumference. The angles are chosen so that as the rotor turns, the flow over any given rotor blade 28 begins to separate from the blade (as in FIG. 1), and then reattaches to it. Each rotor blade undergoes such a cycle at least once, and preferably plural times, during each revolution of the rotor.

The stator blades 26 are arranged in multiple groups M, each with K blades (K=1 to Kₙ), and the notation used in FIG. 3 to identify the stator blades is “26_{M,K}.” Groups M=1 and M=2 are depicted in FIG. 3, but there can be any number of such groups. Likewise, Kₙ=7 in FIG. 3, but those skilled in the art will appreciate that the number of stator blade groups M, the number K of individual stator blades in each group, and the number of rotor blades, are all chosen to obtain the desired performance under specified operating conditions.

Each stator blade also has an airfoil cross-section and its camber line forms a turning angle θ relative to the fan axis and therefore to the velocity V_{∞} of the air entering the fan stage. For delayed stall lift enhancement, the turning angle of the blades within each group gradually increases from θ₁ and then gradually decreases from a maximum value to θ₇. Those skilled in the art will recognize that the cyclic variations in flow can be provided by variations in other geometric properties of the blades, such as camber, chord length, airfoil shape, and/or blade spacing.

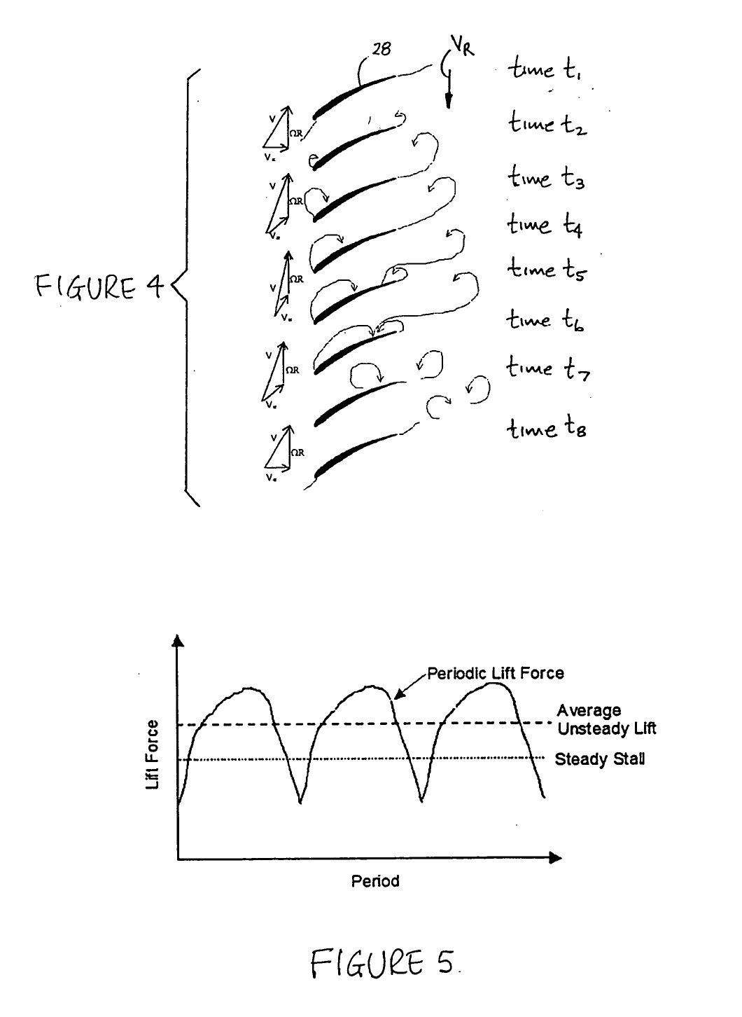

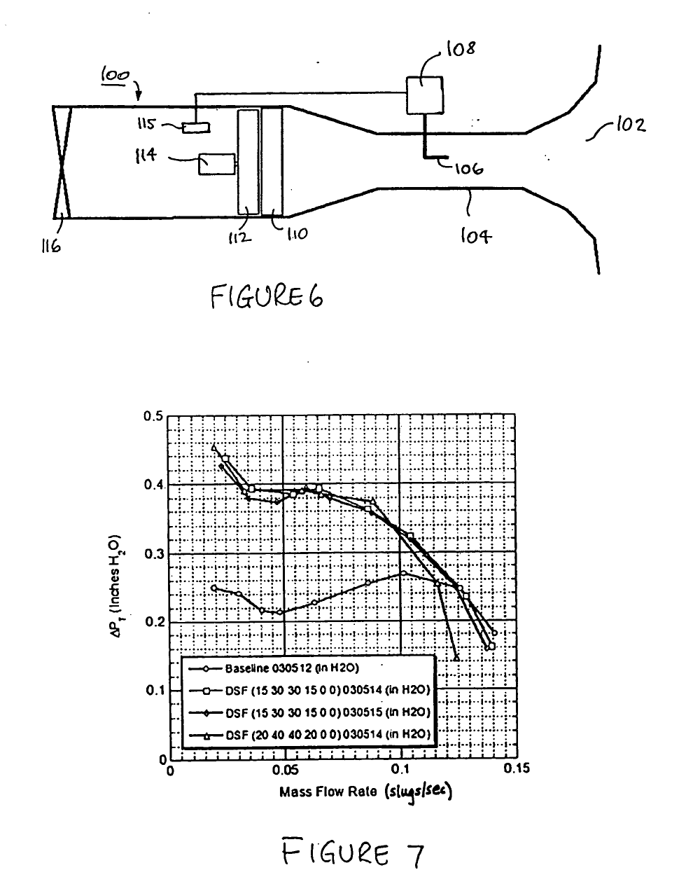

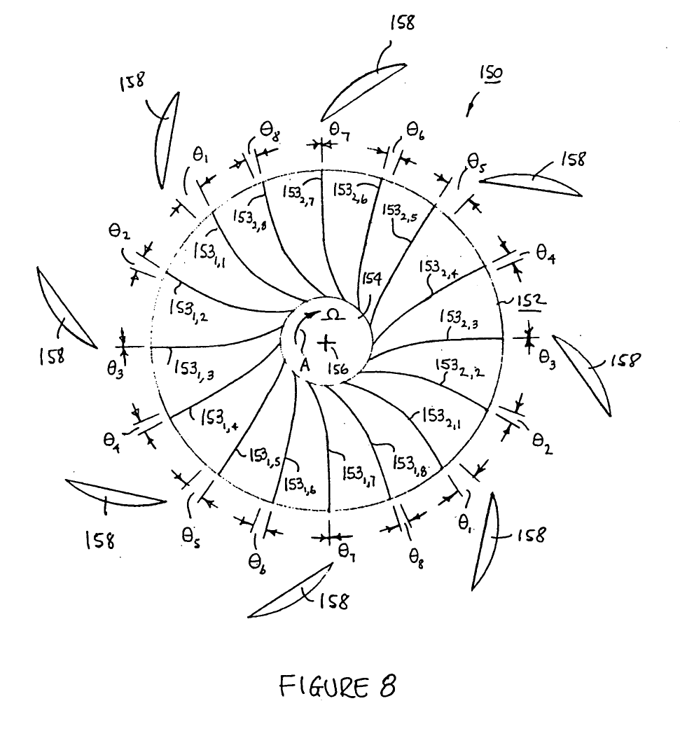

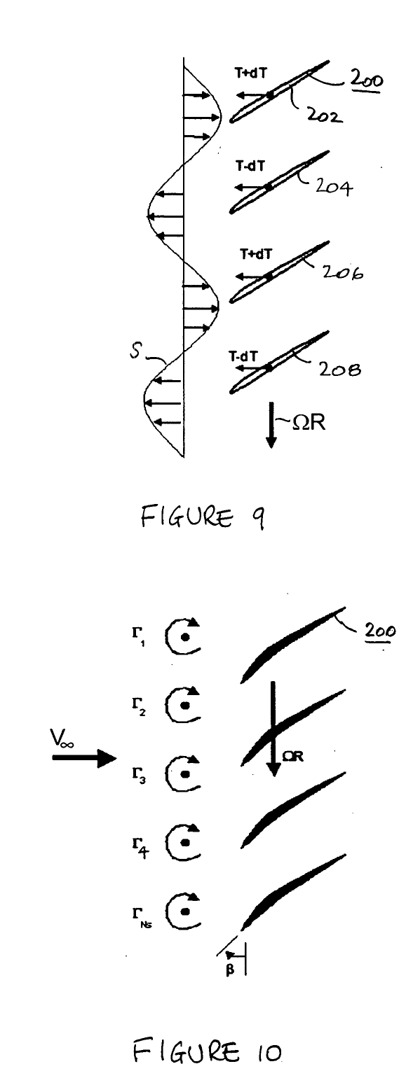

FIG. 4 notionally depicts the flow over a single rotor blade 28 at times t₁ to t₈ as the rotor rotates. At time tI the velocity vector V_{∞} of the flow from the stator in this example is generally axial to the engine (see θ for stator blades 26_{M,1} in FIG. 3). The working medium velocity V relative to the rotor blade is the vector sum of V_{∞} and V_{R} (ΩR). The rotor blade is oriented so that under the operating conditions shown, the flow over the rotor blade is fully attached as in conventional turbomachinery. However, at subsequent times t the rotor blade 28 encounters a relative velocity V that first increases in magnitude and changes direction, and then decreases in magnitude and begins to return to its original direction, in accordance with the different turning angle θ of each stator blade that is passed by the rotating rotor blade.

So at time t₂, for example, the velocity vector V_{∞} has changed as a result of the change in the stator blade turning angle. Thus, while V_{R} remains constant, the resultant velocity V of the working medium becomes larger and approaches the rotor blade at a steeper angle of attack as time passes, as will be appreciated from FIG. 3. The turning angle of the stator blades in each group M is chosen to cause air flow over the rotor blade begin to operate under the influence of the vortical flow characteristic of delayed stall, as depicted in FIG. 1. Then, the rotor blade passes the stator blades in the group with a smaller turning angle θ.

Accordingly, the flow reattaches to the rotor blade by time t₈, after which the cycle depicted in FIG. 4 is repeated. Each rotor blade 28 experiences the same flow cycle during each revolution of the rotor.

FIG. 5 notionally depicts the resultant lift on a single rotor blade 28. In this plot the abscissa is time and the ordinate is lift. The fine dotted line depicts the theoretical maximum lift obtainable in steady-state flow, namely the lift at the point just before the lifting element (rotor blade) stalls. In contrast, delayed stall lift enhancement generates a much greater peak lift. And although the periodic lift force typically will be below the steady-state stall limit for short periods, the average of the unsteady lift force over time is increased, as shown by the coarser dotted line. Since the performance of the fan depends on the magnitude of the lift generated by each rotor blade, delayed stall lift enhancement provides a significant performance improvement.

FIG. 5 also illustrates an inherent feature of apparatus incorporating delayed stall lift enhancement, namely that the cyclic variations in flow can introduce periodic variations in thrust when delayed stall lift enhancement is applied to devices such as propellers and marine propulsors. While these variations may be undesirable for certain applications, the nature of delayed stall lift enhancement also inherently includes a manner of minimizing variations in the thrust. That is, since the flow variations are cyclical in nature, their periodicity can be controlled by carefully selecting the number and properties of the propeller blades and of the upstream device that directs the flow into the propeller. Moreover, the plot in FIG. 5 represents the lift generated a single rotor blade. Accordingly, it will be immediately apparent that by judicious selection of the number and properties of the components of the apparatus, the phases of the periodic lift forces on all of the individual propeller blades can be controlled to minimize the difference between the total maximum and minimum thrust generated by all of the blades as the propeller rotates. Conversely, there may be applications in which it is desirable to maximize these thrust variations. For example, such thrust variations can be used in a pump to provide a pulsating water jet from a pressure washer to enhance its cleaning action, or thrust variations could be used to increase acoustic signatures of active acoustic countermeasure devices such as acoustic decoys.

Implementation of this force tailoring aspect of delayed stall lift enhancement can best be understood by referring also to FIGS. 3 and 4. As previously explained, proper selection of the onset flow variation period, magnitude, and/or direction, results in each rotor blade 28 undergoing periodic cycling of the local flow incidence above the steady stall value. In turn, this results in periodic delayed stall lift enhancement on each blade, as shown in FIG. 5. Thus, each blade cycles between stall onset, at which the flow begins to separate from the blade and creates an enhanced lift, resulting in the formation of a leading edge vortex, and flow reattachment when the leading edge vortex detaches and convects downstream (see FIG. 1).

The onset flow variation period can range from a minimum of one cycle in 360° to any integer number of such cycles, limited only by the ability to impart the required upstream periodic flow variations that induce the delayed stall phenomenon. By selecting the number of onset flow cycles per revolution relative to the number of rotor blades, the system can be designed for particular phasing of the unsteady delayed stall loading on individual blades, which in turn determines the integral effect on the total rotor system. For example, providing M cycles/revolution in the onset flow variation, and using 2MJ rotor blades, where J=1, 2, 3, . . . , will cancel the variations in thrust produced by individual blades and thus cancel moments transverse to the propeller axis. And in a propeller with N blades, and an integer multiple of N cycles/revolution in the onset flow variation, the unsteady response of all of the blades will be in unison.

Working Example

FIG. 6 is a schematic depiction of a test rig 100 constructed to demonstrate the increase in pressure rise obtainable using a stator/rotor combination like that depicted in FIG. 3, as compared to that obtainable with a conventional rotor/stator combination. An inlet 102 admitted air to a throat section 104 containing a pitot static tube 106 connected to instrumentation 108 to determine pressure and the mass flow rate through the device. The inlet had a bell-shaped fairing and a honeycomb-like flow straightener (not shown) to minimize swirl in the air flow introduced to the throat section. A fan stage downstream of the throat section 104 comprised a stator depicted schematically at 110. The stator was located immediately upstream of a rotor depicted schematically at 112 driven by a variable speed motor 114. Additional measuring apparatus 115 connected to the instrumentation measured the pressure of the air exiting the fan stage. A flow control valve 116 was disposed at the exit of the test rig.

The rotor 112 comprised eight untwisted blades with a NACA 0006 airfoil cross-section having a 4″ chord. They were mounted to a hub (not shown) with a 6″ diameter in a manner that permitted their pitch (angle of attack) to be changed for different test runs. The section of the duct containing the fan stage was 22″ in diameter, so each rotor blade had a span of about 8″. The stator 110 comprised 12 blades identical to the rotor blades. They were attached to the hub and the wall of the test rig in a manner that permitted their pitch to be changed individually, as well as permitting them to be removed for test runs involving different numbers of stator blades.

FIG. 7 plots the results of a series of tests using the test rig depicted in FIG. 6. The abscissa of this graph is the mass flow rate of air through the fan (controlled by adjusting the flow control valve 116), and the ordinate is the rise in total pressure rise across the fan, measured in inches of water. For these tests, the rotor blades were set to have a pitch of 45° relative to the axis of the fan. The motor rotational speed was 1125 rpm. One test was run with all of the stator blades having a turning angle θ=0° in order to establish a baseline against which to measure the results achieved by using a stator configuration implementing delayed stall lift enhancement. The results of this test are depicted by the plot labeled “Baseline 030512 (in H2O).” The remaining plots indicate the results achieved by implementing stator turning angle distributions in accordance with delayed stall lift enhancement. In these tests, there were two groups M of stator blades, with six blades in each group (K=6). The notations identifying these plots follow the convention “DSF (θ₁, θ₂, θ₃, θ₄, θ₅, θ₆),” wherein θ represents the turning angle relative to the fan axis and the subscript is the number K of a particular blade in the group. In other words, for the first “DSF” plot, the 12 stator blades had turning angles of 15°, 30°, 30°, 15°, 0°, 0°, 15°, 30°, 30°, 15°, 0°, respectively.

As FIG. 7 illustrates, a fan incorporating delayed stall lift enhancement significantly increases the pressure rise achieved under proper operating conditions. At lower mass flow rates, there are significant differences in pressure rise between the results achieved with a conventional fan (the baseline plot) and fans incorporating delayed stall lift enhancement. Under these loading conditions, a conventional fan, having stator blades that provide the same turning angle around the fan circumference, operates such that the pressure rise across the fan increases as the flow rate decreases, up to a maximum pressure rise where the fan blades begin to stall. At this point, further reduction in the mass flow causes the rotor blades to enter a steady stall regime in which the pressure rise across the fan drops significantly.

In contrast, fans that take advantage of cyclical delayed stall show an increase in pressure rise for a given mass flow rate. Additionally, delayed stall lift enhancement provides a much higher pressure rise at lower mass flow rates, and thus offers a much wider mass flow operating range (and increased stall margin). The pressure rise vs. mass flow curves in FIG. 7 tend to converge at high mass flow rates because under these conditions the rotor blades are very highly loaded and operating far from the high incidence conditions where blade stall occurs.

Additional Attributes of Delayed Stall Lift Enhancement

It will be appreciated from the above discussion that the above application of delayed stall lift enhancement involved the insight to consider the flow over a flapping, pitching insect wing from the vantage point of the wing itself. To an observer moving with the wing, the wing is fixed and the angle of attack of the approaching flow varies cyclically. That insight led to the realization that such variations could be applied to rotating machinery, which by its nature involves cyclic motion. That is, rotating components by their nature operate cyclically, and the present implementation of delayed stall lift enhancement takes advantage of that property to introduce cyclical variations to the flow approaching a cascade of lifting elements without the necessity of incorporating complex mechanisms to vary the configuration of the apparatus during operation. Thus, systems in accordance with these principles can be completely passive and involve no moving parts beyond those already present in rotating machinery. Accordingly, delayed stall lift enhancement can introduce significant performance improvements into a robust, durable structure. It can also be easily retrofitted into existing propulsion and turbomachinery apparatus simply by altering any existing stator, or adding one, to introduce the necessary inlet flow variations to achieve delayed stall lift enhancement.

Even though the above discussion of general principles uses an embodiment incorporating just a rotating cascade, those skilled in the art will readily appreciate that delayed stall lift enhancement can be applied in a variety of ways to myriad different apparatus. For example, the stator used to vary cyclically the angle at which flow in directed to the rotor can be replaced by any device that provides a cyclic variation in a flow parameter that will cause each rotor lifting element to cycle through a flow regime in which the flow begins to separate from the lifting element, as shown in FIG. 1, and then reattaches thereto. With that it mind, it will be appreciated that the stator discussed above can be replaced with a counter-rotating rotor with blades corresponding to the stator blades 26 discussed above. In fact, the operational principles discussed above using a stator to illustrate delayed stall lift enhancement apply equally to using a counter-rotating impeller in place of the stator. In addition, implementation using a counter-rotating impeller can also be retrofit to an existing apparatus.

Delayed stall lift enhancement can be realized in myriad other forms, as well. As one example, the embodiment discussed above in connection with FIG. 2 is a single stage fan, with one rotor and one stator. Delayed stall lift enhancement is applicable to a multiple stage device, in which the flow exiting the rotor of one stage is directed into the stator of a downstream stage. In addition, the airfoils comprising the blades of the stator (or counter-rotating impeller) can be varied by changing geometric properties other than turning angle. For example, the blades' airfoil configuration (such as camber, chord length, etc.), the spacing between adjacent blades, and other properties can be controlled in the manner discussed above to periodically effect the increased lift associated with delayed stall. Still other variations are possible, in that the geometric properties of any given blade can be controlled during operation to account for different operating conditions. This could be accomplished in a number of ways. One convenient structure for making adjustments during operation could use shape-memory alloy tabs or tab actuators, as discussed in U.S. Pat. Nos. 5,752,672 to McKillip and No. 6,345,792 to Bilanin et al., to change the blades' turning angles. The disclosures of those patents relating to the manner of implementing such structure are incorporated herein by reference. Such tabs could be incorporated on FIG. 3's stator blades 26 to selectively change their turning-angles to adjust for operation of the stator/rotor combination under off-design conditions.

In addition, the rotor blades 28 can be skewed, that is, angled in the direction of the rotational axis, which, as is known, will introduce a radial component into the flow downstream of the blades. Based on insect studies like those already discussed, a radial flow component in the flow directed toward the cascade of lifting elements should stabilize the leading edge vortex generated at the onset of stall. That should likewise prolong the duration of the enhanced-lift condition. If the device for introducing a cyclic variation in the flow directed to the rotor blades 28 is itself a counter-rotating rotor, as discussed above, its blades can be skewed either instead of the rotor blades 28, or both the rotor blades 28 and the blades of the upstream counter-rotating rotor can be skewed.

A particularly advantageous manner of implementing delayed stall lift enhancement in a stator/rotor combination like that discussed above models the flow conditions at the rotor cascade inlet as a series of local velocity triangles such as those depicted in FIG. 4. The modeling technique starts with the steady rotor stall operating conditions (rotor rotation speed, rotor geometry, and uniform inlet flow conditions), to which a periodic circumferential variation in inlet flow properties is added to initiate delayed stall lift enhancement on each individual rotor blade. While delayed stall can be introduced through a combination of cyclic variations in either or both of axial flow velocity or swirl velocity, a preferred approach introduces variations in swirl velocity by proper design of an upstream stator, as discussed above in connection with FIG. 3. Generally, the occurrence or degree of delayed stall lift enhancement for an isolated pitching airfoil is a function of the reduced frequency of oscillation, the mean incidence of the oncoming air flow relative to the airfoil chord, and the amplitude of the pitching motion.

The existence of delayed stall is modeled in accordance with the conventional dimensionless parameter “reduced frequency of oscillation,” adapted for use with rotating blades by defining it in relation to the blade semi-chord as follows:

$$k = ( \frac{M Ω}{V} ) ( \frac{c}{2} )$$

where k=reduced frequency, M is the number of inlet flow cycles per revolution, Ω is the rotor angular velocity in radians/sec., c is the chord length of the blade airfoil section being considered, and V is the average total velocity of the air flow approaching the rotor blade (see FIG. 4). It is known that with the proper mean incidence, and pitching amplitude around the mean incidence, an airfoil is in a delayed lift enhancement regime for k>0.01, and that the degree of lift enhancement generally increases as k increases to a maximum around k=O(1). It is believed that the advantages of delayed stall lift enhancement will be achieved when O(1)>k>0.1 over the entire operating range of a particular rotor.

In applying the present modeling technique, the steady rotor stall operating conditions are first determined using conventional methods. For a particular rotor geometry (airfoil cross-sectional shape, chord length, pitch angle, radius, etc.), rotational speed, mass flow rate through the rotor and free stream velocity (V₂₈), the average total velocity V can be determined. The reduced frequency k is then set to be O(1) by specifying M (the number of flow variation cycles per rotor revolution) in accordance with the above equation, rearranged as follows:

$$M = ( \frac{2 Vk}{Ω c} )$$

M is then rounded to the nearest integer, which is required by definition to make the inflow variation periodic in 360°. Next, the inlet flow cycle is defined by considering local rotor velocity triangles as a function of circumferential position. See FIG. 4. Starting with steady rotor stall onset incidence, a circumferential variation in the inlet flow is superimposed on this mean flow, which variation may include any combination of swirl variation and/or axial flow variation such that the resulting local rotor flow incidences will cycle between 10° below and 20° above the steady stall incidence. With the flow incidence range thus defined, the turning angles of the upstream stator blades or inlet guide vanes are chosen to provide an inlet flow that yields the desired cyclic variation in the rotor incidence. In theory, the incidence would be raised as rapidly as possible in the cycle, held at the high incidence for approximately half the cycle, and then dropped back to a low value just long enough for the flow on the rotor blade to recover (reattach). In practice, the inlet flow cyclic structure is limited by the number of stator blades and the maximum local flow turning possible through the stator blade row.

The approach used in the working example discussed above used circumferential variation of stator pitch (turning angle) to accomplish the rotor inlet incidence variation. The pitch variations of the 12 stator blades used in that example are mentioned above, and were determined by using a mean turning angle of 10° and varying it between 10° below and 20° above that value. It should be noted that that range of angles is exemplary, and significant lift enhancement is possible by varying the stator blade turning angle through a range 5° below and 15° above the mean value.

It will be appreciated that this local-velocity-triangle design approach can be incorporated into a three-dimensional stator/rotor design analysis, which will increase its accuracy as a modeling tool but also introduce significant complexity by utilizing equations that require more computing power and longer computational times. Accordingly, it is preferable to identify the particular flow parameters that have the greatest potential influence on the outcome of the analysis. Among these will be the stator blade pitch distribution, which can be modeled as a baseline distribution and a superimposed two-parameter linear twist variation along the blade span, the distance between the stator and the rotor, and the pitch angle of the duct, if one is present. In addition, rotor blade flexibility can be used to enhance the effects of delayed stall lift enhancement. That is, the twist of a rotor blade changes along the blade span under fluid dynamics forces, and this property can be used in conjunction with appropriate stator design to overcome inherent limitations in the amount of turning that the stator blades can impart before they undergo flow separation. If these aeroelastic effects are factored into the model, it will introduce additional parameters such as the blade passage frequency (that is, rotational speed), the stiffness properties of the blades (for example, their torsional and lateral stiffness constants and elastic axis location), and inertial parameters such as the zeroth, first, and second sectional mass moments.

Delayed stall lift enhancement can also achieve noise reductions in rotating propulsion devices, which is particularly advantageous in marine applications such as ship or torpedo propellers, as well as in aeronautical applications. It is known that the sound radiated by rotating machinery increases as the 4^{th}, 5^{th}, or 6^{th} power of the angular velocity of its rotational components, depending on the type of sound source. For marine applications, particularly for the military, the noise generated by rotating machinery is of particular interest. Not only does a rotating device (such as a propulsor) radiate sound, but the metal body to which it is attached (a submarine, torpedo, or surface vessel) acts as an even larger sound source. Because delayed stall lift enhancement increases the energy transferred between the propulsor and the working medium at a given angular velocity, it can provide the same thrust at a lower angular velocity. In addition, with the thrust increases available using delayed stall lift enhancement, a propeller with a smaller diameter can produce the same amount of thrust, thus lessening the propulsor volume required for a given vessel.

Nor is delayed stall lift enhancement limited to the use of stator blades to direct the fluid into a rotating cascade of lifting elements. As already pointed out, it can be achieved by any method by which flow is introduced to a cascade in a manner that varies a parameter of the flow relative to each lifting element in repeating cycles to cause the flow relative to each lifting element to begin separate and then reattach periodically. For example, this could involve changing the velocity and/or swirl of the flow entering the lifting element cascade. Thus, a circumferentially cyclic variation in the onset flow to the cascade could be introduced through careful tailoring of upstream duct geometry (for example, by using a non-circular duct). The same effect could be accomplished using jet blowing devices in struts upstream of the cascade directing fluid at appropriate angles varying around the rotor circumference, an upstream flow screen that varies the angle of the onset flow circumferentially, or any other device that one skilled in fluid dynamics might envision to vary in repeating cycles a parameter of the flow entering a cascade of lifting elements.

By way of illustration of other possible applications, the centrifugal pump illustrated in FIG. 8 is an example of an embodiment in which the cascade of lifting elements is stationary and the device for directing fluid into the cascade rotates. A centrifugal pump 150 comprises a centrifugal impeller 152 with a plurality of impeller elements 152_{M,K}, which will be described in more detail shortly. The impeller elements are arranged around a hub 154 capable of rotating on an axis 156 in the direction of the arrow A at an angular velocity Ω. As is conventional, the working fluid enters the impeller at a radially inward location near the hub 154, and the impeller elements direct the flow to the impeller outlet disposed at its periphery. The flow exits the impeller outlet and is directed into a diffuser (not shown). A cascade of lifting elements 158 is disposed around the periphery of the impeller, and each lifting element 158 has an airfoil shape. The cascade of lifting elements has an inlet into which is directed working fluid exiting the impeller outlet. A typical compressor/pump with this basic design is shown in U.S. Pat. No. 5,368,440 to Japikse et al.

To incorporate delayed stall lift enhancement, the conventional design is altered so that the impeller device for directing fluid into the cascade inlet comprises impeller elements 153 with cyclically varying configurations arranged in M groups, each having K impeller elements. The notation in FIG. 8 corresponds to that in FIG. 3, except that M=2 and K=8 in FIG. 8. Therefore, each of impeller elements 153_{M,1} directs the flow toward the cascade of lifting elements 158 at an angle θ₁; each of impeller elements 153_{M,2} directs the flow toward the cascade of lifting elements 158 at an angle θ₂; each of impeller elements 153_{M,3} directs the flow toward the cascade of lifting elements 158 at an angle θ₃; each of impeller elements 153_{M,4} directs the flow toward the cascade of lifting elements 158 at an angle θ₄; each of impeller elements 153_{M,5} directs the flow toward the cascade of lifting elements 158 at an angle θ₅; each of impeller elements 153_{M,6} directs the flow toward the cascade of lifting elements 158 at an angle θ₆; each of impeller elements 153_{M,7} directs the flow toward the cascade of lifting elements 158 at an angle θ₄; and each of impeller elements 153_{M,8} directs the flow toward the cascade of lifting elements 158 at an angle θ₈. The exit angle θ of the impeller elements within each group M gradually changes around the periphery of the impeller; in that fashion the exit angles θ of the different impeller elements 153 correspond to the turning angles θ of the different stator in FIG. 3. In a centrifugal pump or compressor the pressure rise can be enhanced by increasing the lift provided by the cascade of lifting elements 158. Accordingly, the angles θ₁ to θ₈ are chosen such that each lifting element 158 experiences flow cycling like that depicted in FIG. 4, in which the flow repeatedly begins to separate from each lifting element and then reattaches.

The above describes how delayed stall lift enhancement devices can assume myriad forms for use with different embodiments in accordance with the specific application under consideration.

Acoustic Tailoring Applications

A basic idea underlying the present invention is the introduction of non-uniformities into the flow entering a rotating impeller in a manner that tailors the impeller's acoustic signature to meet any of a wide variety of acoustic objectives, either in the near or far acoustic field. One way of introducing the desired flow non-uniformities in accordance with the invention is through the use of a specially constructed upstream stator. For example, such a stator could have any combination of one or more of the following geometric properties varying circumferentially (and/or radially) from blade to blade: pitch, cross-sectional geometry (such as thickness and/or camber distribution, chord length, etc.), blade-to-blade spacing, sweep, or any other geometric property capable of introducing variations in the flow exiting the stator and entering the rotor downstream of the stator.

The introduction of circumferentially and/or radial variations in the flow entering the rotor creates a time-dependent and periodic unsteady pressure distribution over each rotor blade, and thus changes each rotor blade's acoustic signature. In combination with all of the other rotor blades, this results in an unsteady, rotating pressure field with unique acoustic properties in both the near and far fields. Utilizing this insight, it is possible to construct special unsteady pressure fields that result in acoustic cancellation or amplification of some or all frequencies in the near or far fields. For example, it is possible to optimize variations in the flow entering the rotor to minimize the far field acoustic sound power. Or, flow variations can be introduced that cancel some frequencies and amplify others, resulting in a specific acoustic signature that would mimic another acoustic source and thus act as an acoustic decoy useful in various naval situations.

In many applications involving creating a particular acoustic field for the above purposes, it is important that the propulsor to which the inventive principles are applied provide a specified thrust. That is, a propulsor designed to provide a given acoustic signature must still provide a specified thrust, which can be achieved more readily by using delayed stall lift enhancement, as described above. Moreover, delayed stall lift enhancement, as applied to a rotating impeller, involves introducing variations in the properties of the flow entering the impeller, and thus provides the opportunity to introduce the flow variations in a manner that tailors the acoustic response of the rotor in accordance with the principles of the present invention.

In general, the acoustic tailoring principles underlying the present invention can be illustrated by considering an example by which a propeller outputs reduced acoustic power. For simplicity, the stator-propeller combination will be modeled in the following discussion as a two-dimensional cascade, with the unsteady thrust being considered as unsteady point loadings at a fixed radial position on the propeller blades. Introduction of specific symmetries between the number of cyclic variations in the flow entering the propeller will result in cancellation of acoustic energy in the propeller far field. In particular, when the flow entering the propeller varies by M cycles/360°, and there are 2MJ propeller blades (J=1, 2, 3, . . . ), then the far filed acoustic signature can be represented as a combination of dipole and quadrapole acoustic sources. Assuming point loads and symmetry, the minimization of far field acoustic sound power reduces to a minimization of the propeller rotational speed, while holding the thrust constant and minimizing an unsteady component of the total thrust, as shown in the following example.

FIG. 9 schematically depicts a rotating propeller 200 with four blades 202, 204, 206 and 208. The blades are shown in cross-section at a radius R, and thus travel at a velocity V_{R}=ΩR. If delayed-stall inducing swirl could be made to vary around the propeller circumference as a continuous function, represented by the curve S, then the thrust generated by each of the propeller blades 202 and 206 would be T+dT, and the thrust generated by each of propeller blades 204 and 208 would be T−dT. As mentioned above, the thrust is modeled as a force acting on a point (the centroid) of each blade cross-section. The total thrust would thus be 4T, with the cyclic variations dT in the thrust generated by each blade cancelled out of the total thrust. This accords with the discussion above pointing out that substantially uniform total thrust and acoustic cancellation are possible for propellers with 2MJ propeller blades, where J=1, 2, 3, . . . , if M cyclic variations are introduced into the propeller inflow per revolution (M being an integer).

The prior art algorithms published by Boeing and Johnson discussed above can be adapted to simulate the fluid dynamic response of the propeller 200 to flow introduced to the propeller by discrete stator blades. The swirl introduced by the stator blades is modeled as a series of vortices superimposed on a flow with a uniform free stream velocity V_{∞}as shown in FIG. 10. That is, a stator according to the present invention is represented by a series of vortices VXᵢ, and each stator blade in FIG. 3 is represented by a separate vortex with a circulation Γᵢ corresponding to its turning angle θₖ. The free stream velocity V_{∞} in FIG. 10 corresponds to the same parameter shown in FIG. 3. The propeller 200 rotates at an angular velocity Ω, which corresponds to a velocity ΩR. (See also FIGS. 3 and 9.) Each propeller blade has a pitch β relative to the axis of rotation (see FIGS. 2 and 3).

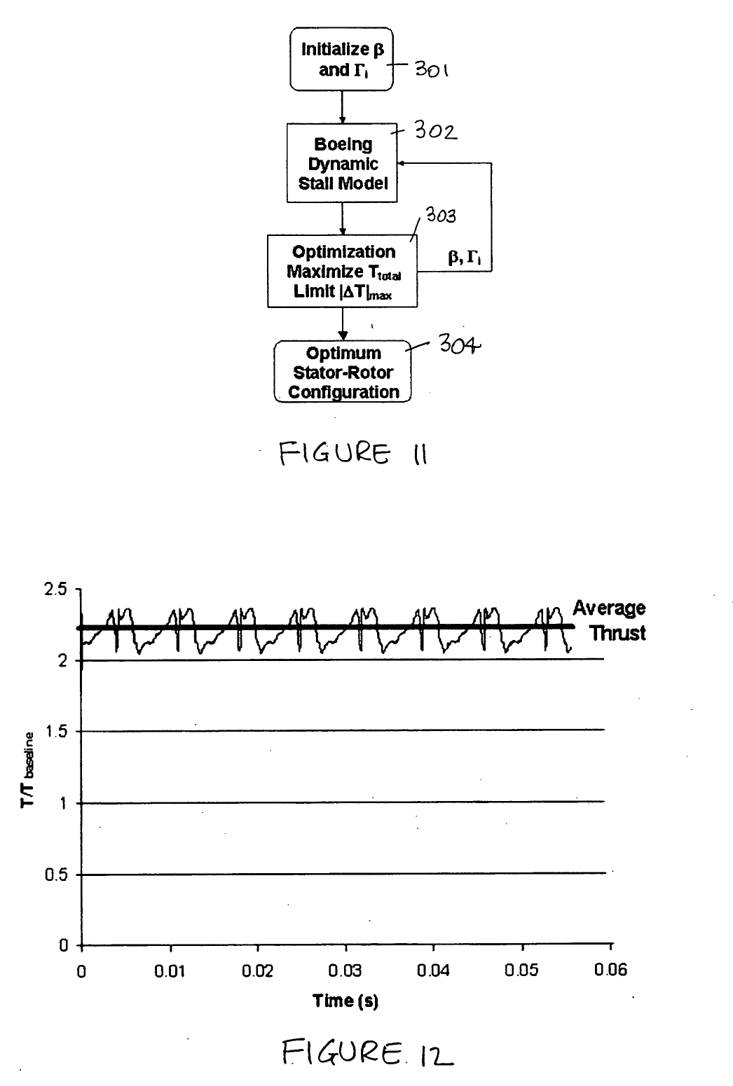

In accordance with the general principles discussed above, the overall thrust of the propeller 200 can be maximized, and the thrust variations minimized, using the algorithm represented by the flow chart shown in FIG. 11 in conjunction with the mathematical model depicted in FIG. 10. The algorithm begins with step 301, in which essentially arbitrary initial values are assigned to the rotor blade pitch β and circulation Γᵢ. For the propeller in FIG. 10, N=4, so an initial value for each circulation Γᵢ is introduced for i=1 to 4. These values are used by the Boeing dynamic stall model in step 302 to calculate properties of the flow field, including the total thrust T (the force generated by the rotor in the direction of the free stream velocity V_{∞}), and the thrust variations ΔT (=Tₘₐₓ−Tₘᵢₙ) over a chosen time interval. The parameters β and Γᵢ are then adjusted incrementally in step 303 and new values for T and ΔT are calculated in step 302. The new calculated values are compared to the previous ones in step 303, to determine the differences between successive calculated values for T and ΔT. This iterative process is used to converge on a maximum value for T and a minimum value for ΔTₘₐₓ. When those values are determined, step 304 translates the results into the geometric parameters of the rotor/stator configuration.

This algorithm was used to calculate the values for T and ΔT plotted in FIG. 12. The abscissa of this graph is time in seconds, and the ordinate is the ratio of T for a propeller optimized using the algorithm in FIG. 11 to the thrust of the propeller before optimization (T_{baseline}). The baseline propeller had four blades (as in FIG. 10) and a radius R=1 foot, with a pitch β=30.5° at a radius of r/R=0.8 (80% blade span) and a NACA 0012 airfoil cross section (having a coefficient of L C_{L}=0.6). The operating conditions were V_{∞}=50 knots (84 ft./sec.) and an angular velocity Ω=226 radians/sec. FIG. 12 shows that the average optimized thrust T is over twice the baseline thrust (T/T_{baseline}>2). In addition, the maximum variation in the optimized thrust (Tₘₐₓ−Tₘᵢₙ) as compared to the thrust itself (|ΔT|ₘₐₓ/T) is only 0.15, in spite of the cyclic nature of the lift generated by the propeller blades. It is believed that (|ΔT|ₘₐₓ/T) can be reduced even further with other optimization techniques, but the example given here will suffice to illustrate an important advantage of the present invention.

This increased thrust can in turn be employed to provide a substantial reduction in radiated noise, even though it introduces a possible additional noise source, namely the small variations in total thrust as shown in FIG. 12. The reduction in acoustic signature available using the present invention is particularly advantageous in marine propulsors, but the same principles govern other applications, and noise reduction is therefore also possible in applications such as turbomachinery and pump systems. In that connection, delayed stall lift enhancement is used to reduce the rotor rotation speed while holding the thrust (or stage pressure rise) constant. The device symmetry and circumferential variation in the stator properties promote cancellation of the acoustic far field resulting from the quadrapole noise introduced by the rotating blades with individual blade loading variations. In turn, the classic dipole acoustic source resulting from the steady load on the rotating blades is reduced by operating the rotor at constant thrust but at a lower angular velocity Ω. For the example calculated in the previous paragraph, if the stator/rotor system is designed to maximize the delayed stall lift enhancement effect while providing the same thrust, the propeller rotational speed can be reduced by 36%. This results in a large noise reduction because the radiated acoustic power in the far field scales as Ω² if the thrust is held constant.

For a four-bladed configuration with two cyclic variations in the onset flow from the upstream stator (M=2, J=2), assuming an acoustically compact radiated sound source from a stator-rotor configuration, squaring the pressure, and integrating over a large spherical surface leads to the following expression for the total radiated sound power:

$$P ∝ \frac{4 π}{3} ( 128 ) {Ω}^{2} {\overline{T}}^{2} + \frac{8 π}{15} \frac{( 656 ) {Ω}^{4} {s}^{2} ( Δ T )}{{c}^{2}}$$

where \overline{T} is the mean thrust generated by each blade, ΔT is the amplitude of the unsteady component of the thrust generated by each blade (see above), c is the speed of sound and s is the radius of the propulsor. In this expression, the first term on the right is the power radiated from a dipole source and the second term is the power radiated from a quadrapole source. Consider a typical propeller application with s=1 ft., Ω=226 radians/sec., c=5000 ft./sec. for water, and assume ΔT/T˜O(1). The dipole contribution is O(10⁴) larger than the quadrapole term, or put another way, the sound power radiated by the dipole is 40 db higher than that of the quadrapole. Therefore, the quadrapole term, attributable to the thrust variations ΔT discussed above (Tₘₐₓ−Tₘᵢₙ), is negligible relative to the dipole noise, which is a direct consequence of the load symmetry designed into the propeller (that is, four blades with two delayed stall cycles per propeller revolution). Hence, the sound power reduction achieved by reducing the rotational speed is much greater than the increase in sound power related to the introduction of unsteady loading on each blade through using delayed stall lift enhancement in accordance with the invention.

The amount of sound power reduction can be considered by taking a baseline steady thrust propeller configuration with a thrust T_{baseline} and a rotational speed Ω_{baseline}, and a delayed-stall configuration with an average thrust T_{DS} and rotational speed Ω_{DS}. Now assume that the delayed stall configuration has the same thrust as the baseline configuration, but with the lower rotational speed permissible because of the higher blade loading possible with the present invention. The reduction in total sound power is given by the following expression:

$$Sound Power Reduction = 10 log [ \frac{{P}_{DS}}{{P}_{baseline}} ] = 10 log [ \frac{{Ω}_{DS}^{2}}{{Ω}_{baseline}^{2}} ]$$

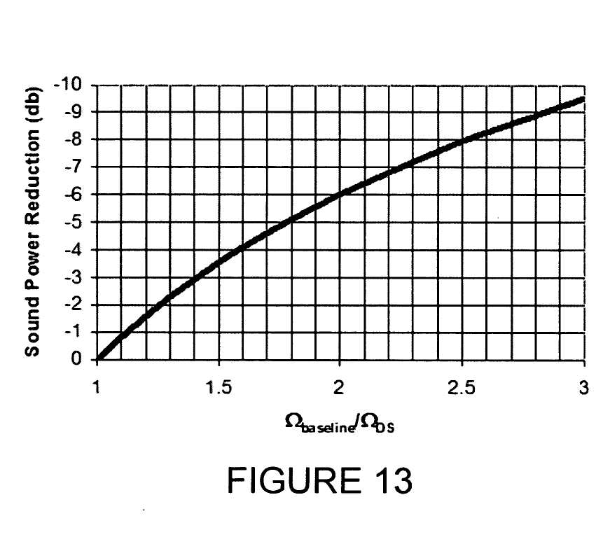

FIG. 13 illustrates graphically the sound power reduction at constant thrust which can be attained by reducing the rotational speed Ω of the propeller using the present invention. For example, in the case discussed above a reduction of 36% in rotational speed (Ω_{baseline}/Ω_{DS}=1.57) corresponds to a predicted far field sound power reduction of 4 db. Far field acoustic cancellation and force cancellation can be implemented for any configuration with 2M blades and M cycles in the onset flow. Those skilled in the art can apply this force and acoustic cancellation concept in other blade number/onset-flow-cycle number combinations through the optimization of the onset flow profile over the 360° cycle.

Those skilled in the art will recognize that the near and far field acoustic signatures and sound power for a marine propulsor depend on the three-dimensional nature of the steady and unsteady pressure distributions over the both the stator and rotor blade rows. Commercially available three-dimensional hydrodynamic and hydro-acoustic simulation tools will enable use of the above approach to design a rotor entry flow field with both radial and circumferential variations, optimized to meet specific acoustic objectives, while maintaining existing thrust requirements. With further design optimization, specific shapes for individual rotor and stator blades can be optimized to provide a desired three-dimensional amplification/cancellation of acoustic frequencies. This is important because the radiated sound depends on the unsteady pressure distribution over all of the rotor and stator blades, not just the net unsteady loading on each blade. The importance of a three-dimensional analysis becomes clearer when considering applications of the invention such as minimizing far field acoustic power levels in torpedoes, tailoring the near field acoustic signature to increase passenger comfort on cruise liners, designing an acoustic signature for repulsing marine animals to prevent injury from contact with the propeller, or designing a specific far field acoustic signature for an acoustic decoy, just to name a few examples.

In addition, for the specific application in which the impeller entry flow variations are induced using a specially designed stator, the stator properties can be varied to cause acoustic cancellation and/or amplification of specific frequencies radiated from both the stator and the rotor. That is, the stator properties can be varied circumferentially and radially to create the desired flow field that meets the required objectives when considering the contribution to the acoustic field by both the stator and the rotor.

Summary

Those skilled in the art will readily recognize that the acoustic tailoring principles underlying the present invention has application to a wide variety of apparatus. Some of them are fans, compressors, turbines, pumps, marine propulsors, and propellers. Applications for such apparatus include military submarines, torpedoes, unmanned underwater vehicles, air handling systems, high performance aircraft propellers, turbochargers, turbines, and other turbomachinery. It is particularly well adapted for implementation in tunnel thrusters such as those used on large ships for maneuvering in close spaces without a tugboat. These devices comprise tunnels through the ship's hull disposed to provide thrust transverse to the ship's axis. The present invention offers the option of placing a stator in the duct upstream of the thruster's propeller element, which can increase the available thrust or, conversely, enable use of a smaller diameter tunnel. The same application can be implemented on ships' podded thrusters, which operate similar to tunnel thrusters, but are separate structures the orientation of which can be changed to vector the thrust in desired directions.

The noise reduction resulting from reduced rotational speed and the tailoring of acoustic radiation will have advantages in all of the above applications. However, these aspects of the invention will be particularly advantageous in marine applications, and even more so in a military setting, as discussed above.

In that connection, only selected preferred embodiments of the invention have been depicted and described, and it will be understood that various changes and modifications can be made other than those specifically mentioned above without departing from the spirit and scope of the invention, which is defined solely by the claims that follow.

What is claimed is:

1. An apparatus for providing propulsive force by increasing the velocity of a fluid working medium, the apparatus comprising:
a rotatable impeller including a plurality of lifting elements spaced from each other, wherein each said lifting element has an airfoil cross-section that provides lift as the fluid working medium travels relative thereto; and
a device for directing the fluid working medium into an inlet of said impeller,
wherein said device varies a parameter of the flow relative to each said lifting element in repeating cycles to cause said apparatus to generate a predetermined acoustic signature characterized by predetermined acoustic energy levels in the fluid at given locations relative to said apparatus.

2. An apparatus as in claim 1, wherein said impeller comprises an axial flow impeller and said lifting elements comprise a plurality of impeller blades arranged around a hub capable of rotating on an axis.

3. An apparatus as in claim 2, wherein said device varies the parameter such that a far field acoustic sound power generated by the apparatus is minimized.

4. An apparatus as in claim 2, wherein said device provides a predetermined acoustic signature by varying the parameter such that selected sound frequencies generated by the apparatus in the fluid are canceled and other selected sound frequencies generated by the apparatus in the fluid are enhanced.

5. An apparatus as in claim 4, wherein the predetermined acoustic signature mimics another sound source and thereby enables the apparatus to act as an acoustic decoy.

6. An apparatus as in claim 2, wherein:
said device comprises a stator with a plurality of stator blades arranged around said axis upstream of said impeller; and
said parameter is a flow angle at which the flow is directed to said impeller, each said stator blade being oriented at a predetermined turning angle for circumferentially varying said flow angle above and below an angle of attack at which each said lifting element experiences steady-state stall.

7. An apparatus as in claim 2, wherein:
said device includes a second axial flow impeller having a plurality of impeller blades arranged around said hub, said second impeller being upstream of said first-mentioned impeller and mounted for rotation on said axis in a direction opposite the direction of rotation of said first impeller; and
said parameter is a flow angle at which the flow is directed to said first impeller, each said blade of said second impeller being oriented at a predetermined turning angle for circumferentially varying said flow angle above and below an angle of attack at which each said lifting element experiences steady-state stall.

8. An apparatus as in claim 1, further comprising an axial flow device, wherein:
said lifting elements are arranged in a first cascade around a hub capable of rotating on an axis;
said device includes a second plurality of lifting elements having an airfoil cross-section arranged in a second cascade around said hub; and
said airfoils in said second cascade have at least one predetermined geometric property for controlling the parameter by varying circumferentially or radially or both from element to element, said property including at least one of lifting element pitch, cross-sectional thickness, camber distribution, chord length, and element-to-element spacing.

9. An apparatus as in claim 8, wherein:
said first cascade includes a first axial flow impeller;
said second cascade includes at least one of (i) a stator with a plurality of stationary blades and (ii) a second axial flow impeller having a plurality of impeller blades mounted for rotation on said axis in a direction opposite the direction of rotation of said first impeller; and
the parameter is a flow angle at which the flow is directed to said first impeller, each said blade of said second cascade being oriented at a predetermined exit angle for circumferentially varying said flow angle to cause the flow relative to each lifting element to begin to separate from the lifting element and then reattach thereto during each cycle.

10. An apparatus as in claim 9, wherein:
said first-mentioned axial flow impeller comprises a propeller for generating thrust used to propel a body through said fluid; and
said geometric property cyclically varies in a predetermined manner to minimize variations in thrust in the direction of said axis.

11. An apparatus as in claim 10, wherein:
said propeller comprises 2MJ blades, M being an integer greater than 1 and J being an integer greater than or equal to 1; and
said second cascade introduces M cyclical variations in said flow angle around the circumference of said impeller.

12. A method of optimizing the acoustic energy signature generated by a propulsor that increases the velocity of a fluid working medium to provide a predetermined propulsive force by rotating an impeller having a plurality of lifting elements spaced from each other, the method comprising the steps of:
varying a parameter of the flow relative to each said lifting element in repeating cycles to cause the propulsor to generate a predetermined acoustic signature characterized by predetermined acoustic energy levels in the fluid at given locations spaced from the propulsor; and
choosing values of the parameter that cause the flow relative to each lifting element to begin to separate from the lifting element and then reattach thereto during each cycle to increase the propulsive force generated by the impeller at a given rotational speed, thereby permitting generation of the predetermined thrust at a reduced rotational speed.

13. A method as in claim 12, wherein the parameter is at least one of the magnitude of the velocity of the flow entering said inlet of said cascade, the direction of the velocity of the flow entering said inlet of said cascade, and the swirl in the flow entering said inlet of said cascade.
